(19) United States
(12) Patent Application Publication
(10) Pub. No.: US 2026/0081268 A1
(43) Pub. Date: Mar. 19, 2026

(54) BATTERY CELL WITH WINDOW FOR OPTICAL SPECTROSCOPY

(71) Applicant: FORD GLOBAL TECHNOLOGIES, LLC, Dearborn, MI (US)

(72) Inventors: Nathan KEMPEMA, Grosse Pointe Farms, MI (US); David BILBY, Royal Oak, MI (US); Elham HONARVARFARD, West Bloomfield, MI (US); Ann Marie STRACCIA, Southgate, MI (US)

(21) Appl. No.: 18/886,241

(22) Filed: Sep. 16, 2024

(51) Int. Cl. H01M 50/129; H01M 50/119; H01M 50/121

(52) U.S. Cl. CPC H01M 50/129; H01M 50/119; H01M 50/121; H01M 2220/20

(57) ABSTRACT

A battery includes a battery cell having an optical window configured to allow external optical spectroscopy of internals of the battery cell. The window includes an aperture formed in a housing of the battery cell, and a layer of material spanning the aperture. The layer of material is at least partially transparent to electromagnetic radiation and is configured to inhibit permeation of gases produced by the battery cell through the window

### TECHNICAL FIELD

This disclosure relates to vehicle traction batteries and more particularly to inspection of battery cells using optical spectroscopy.

### BACKGROUND

Powertrain electrification is used by automakers to improve fuel economy. These systems can have higher electrical ratings and have high- and low-voltage components. The powertrain may include an electric machine powered by a traction battery and/or an engine in the case of a hybrid. The battery may have lithium-ion chemistry.

### SUMMARY

According to an embodiment, a battery includes a unit cell including a cathode, an anode, and a separator. The battery further includes a housing encasing the unit cell and defining an aperture extending at least partially through a thickness of the housing. A metalloid foil is disposed between the unit cell and the housing such that the metalloid foil spans the aperture. The metalloid foil is at least partially transparent to infrared electromagnetic radiation.

According to another embodiment, a battery includes a battery cell having an optical window configured to allow external optical spectroscopy of internals of the battery cell. The window includes an aperture formed in a housing of the battery cell, and a layer of material spanning the aperture. The layer of material is at least partially transparent to electromagnetic radiation and is configured to inhibit permeation of gases produced by the battery cell through the window.

According to yet another embodiment, a traction battery assembly includes an array of battery cells. At least one of the battery cells including a housing defining an aperture extending inwardly from an outer surface of the housing; and an infrared-transmissive metalloid foil disposed within the housing such that the metalloid foil spans the aperture.

### BRIEF DESCRIPTION OF THE DRAWINGS

FIG. 1 is a schematic diagram of an electric vehicle.

FIG. 2 is a schematic drawing of a battery cell.

FIG. 3 is a schematic drawing of an optical window provided on the battery cell.

FIG. 4 is a schematic drawing of another optical window provided on the battery cell.

FIG. 5 shows a cover for the optical window.

FIG. 6 illustrates a reflective methodology for optical spectroscopy.

FIG. 7 illustrates a transmission methodology for optical spectroscopy.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

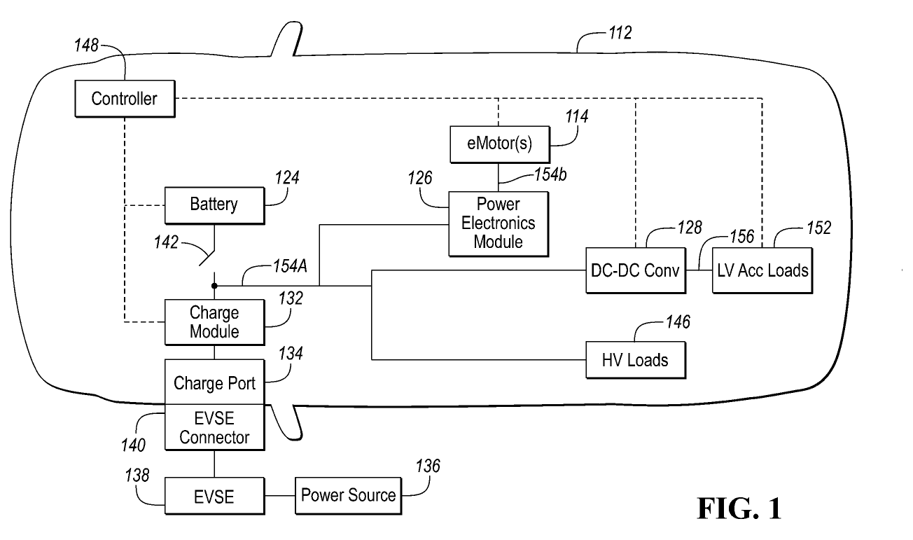

FIG. 1 depicts an electric vehicle 112. The vehicle 112 includes an electrified propulsion system having one or more electric machines 114 mechanically coupled to driven wheels. The electric machines 114 may be capable of operating as a motor or a generator. The electric machines 114 are arranged to provide propulsion torque as well as braking. The electric machines 114 can operate as generators providing fuel economy benefits by recovering energy that would otherwise be lost as heat in a friction-braking system.

A traction battery assembly or battery pack 124 stores energy that can be used to power the electric machines 114. The battery pack 124 may provide a high-voltage direct current (DC) output. The battery 124 includes an electrical distribution system (EDS) 118 that carries power from the cells to loads and vice versa. Portions of the EDS 118 may be components of the battery 124 and other portions may be external to the battery 124. One or more contactors 142 may isolate the traction battery 124 from a DC high-voltage bus 154A when open and may couple the traction battery 124 to the DC high-voltage bus 154A when closed. The traction battery 124 is electrically coupled to one or more power electronics modules 126 via the DC high-voltage bus 154A. The power electronics module 126 is also electrically coupled to the electric machines 114 and provides the ability to bi-directionally transfer energy between AC high-voltage bus 154B and the electric machines 114. According to some examples, the traction battery 124 may provide a DC current while the electric machines 114 operate using a three-phase alternating current (AC). The power electronics module 126 may convert the DC current to a three-phase AC current to operate the electric machines 114. In a regenerative mode, the power electronics module 126 may convert the three-phase AC current output from the electric machines 114 acting as generators to DC current compatible with the traction battery 124.

In addition to providing energy for propulsion, the traction battery 124 may provide energy for other vehicle electrical systems. The vehicle 112 may include a DC/DC converter module 128 that is electrically coupled to the high-voltage bus 154. The DC/DC converter module 128 may be electrically coupled to a low-voltage bus 156. The DC/DC converter module 128 may convert the high-voltage DC output of the traction battery 124 to a low-voltage DC supply that is compatible with low-voltage vehicle loads 152. The low-voltage bus 156 may be electrically coupled to an auxiliary battery 130 (e.g., 12V battery). The low-voltage loads 152 may be electrically coupled to the low-voltage bus 156. The low-voltage loads 152 may include various controllers within the vehicle 112.

The traction battery 124 of vehicle 112 may be recharged by an off-board power source 136. The off-board power source 136 may be a connection to an electrical outlet. The external power source 136 may be electrically coupled to a charger or another type of electric vehicle supply equipment (EVSE) 138. The off-board power source 136 may be an electrical power distribution network or grid as provided by an electric utility company. The EVSE 138 provides circuitry and controls to regulate and manage the transfer of energy between the power source 136 and the vehicle 112. The off-board power source 136 may provide DC or AC electric power to the EVSE 138. The EVSE 138 includes a charge connector 140 for plugging into a charge port 134 of the vehicle 112. The charge port 134 may be any type of port configured to transfer power from the EVSE 138 to the vehicle 112. The charge port 134 may be electrically coupled to a charge module or on-board power conversion module 132. The power conversion module 132 conditions power supplied from the EVSE 138 to provide the proper voltage and current levels to the traction battery 124. The power conversion module 132 interfaces with the EVSE 138 to coordinate the delivery of power to the vehicle 112. The EVSE connector 140 may have pins that mate with corresponding recesses of the charge port 134. Alternatively, various components described as being electrically coupled or connected may transfer power using wireless inductive coupling or other non-contact power transfer mechanisms. The charge components including the charge port 134, power conversion module 132, power electronics module 126, and DC-DC converter module 128 may collectively be considered part of a power interface system configured to receive power from the off-board power source 136.

When the vehicle 112 is plugged in to the EVSE 138, the contactors 142 may be in a closed state so that the traction battery 124 is coupled to the high-voltage bus 154 and to the power source 136 to charge the battery. The vehicle may be in the ignition-off condition when plugged in to the EVSE 138.

One or more wheel brakes (not shown) may be provided as part of a braking system to slow the vehicle 112 and prevent rotation of the vehicle wheels. The brakes may be hydraulically actuated, electrically actuated, or some combination thereof. The brake system may also include other components to operate the wheel brakes. The brake system may include a controller to monitor and coordinate operation. The controller monitors the brake system components and controls the wheel brakes 144 for vehicle deceleration. The brake system also responds to driver commands via a brake pedal input and may also operate to automatically implement features such as stability control. The controller of the brake system may implement a method of applying a requested brake force when requested by another controller or sub-function.

One or more high-voltage electrical loads 146 may be coupled to the high-voltage bus 154. The high-voltage electrical loads 146 may have an associated controller that operates and controls the high-voltage electrical loads 146 when appropriate. The high-voltage loads 146 may include components such as compressors and electric heaters.

The various components discussed may have one or more associated controllers to control, monitor, and coordinate the operation of the components. The controllers may communicate via a serial bus (e.g., Controller Area Network (CAN)) or via discrete conductors. In addition, a vehicle system controller 148 may be provided to coordinate the operation of the various components.

While illustrated as one controller, the controller may be part of a larger control system and may be controlled by various other controllers throughout the vehicle 112, such as a vehicle system controller (VSC). It should therefore be understood that the controller and one or more other controllers can collectively be referred to as a “controller” that controls various actuators in response to signals from various sensors to control functions. The controller may include a microprocessor or central processing unit (CPU) in communication with various types of computer-readable storage devices or media. Computer-readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle. The controller communicates with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU.

In one embodiment, a system controller 148, although represented as a single controller, may be implemented as one or more controllers, may monitor operating conditions of the various vehicle components. According to the example of FIG. 1, at least the electric machines 114, the EDS 118, the traction battery 124, the DC-DC converter 128, the charging module 132, the high-voltage loads 146, and low-voltage loads 152 are in communication with the controller 148. The traction battery 124 also includes a current sensor to sense current that flows through the traction battery 124. The traction battery 124 also includes a voltage sensor to sense a voltage across terminals of the traction battery 124. The voltage sensor outputs a signal indicative of the voltage across the terminals of the traction battery 124. The traction battery current sensor outputs a signal indicative of a magnitude and direction of current flowing into or out of the traction battery 124.

The charging module 132 also includes a current sensor to sense current that flows from the EVSE 138 to the traction battery 124. The current sensor of the charging module 132 outputs a signal indicative of a magnitude and direction of current flowing from the EVSE 138 to the traction battery 124.

The current sensor and voltage sensor outputs of the traction battery 124 are provided to the controller 148. The controller 148 may be programmed to compute a state of charge (SOC) based on the signals from the current sensor and the voltage sensor of the traction battery 124. Various techniques may be utilized to compute the state of charge. For example, an ampere-hour integration may be implemented in which the current through the traction battery 124 is integrated over time. The SOC may also be estimated based on the output of the traction battery voltage sensor 104. The specific technique utilized may depend upon the chemical composition and characteristics of the particular battery.

The controller 148 may also be configured to monitor the status of the traction battery 124. The controller 148 includes at least one processor that controls at least some portion of the operation of the controller 148. The processor allows onboard processing of commands and executes any number of predetermined routines. The processor may be coupled to non-persistent storage and persistent storage. In an illustrative configuration, the non-persistent storage is random access memory (RAM) and the persistent storage is flash memory. In general, persistent (non-transitory) storage can include all forms of storage that maintain data when a computer or other device is powered down.

A desired SOC operating range may be defined for the traction battery 124. The operating ranges may define an upper and lower limit at which the SOC of the battery 124 is bounded. During vehicle operation, the controller 148 may be configured to maintain the SOC of the battery 124 within the desired operating range. In other cases, the battery is recharged when at rest and connected to an off-board power source. Based on a rate of battery depletion and/or recharge, charging of the traction battery may be scheduled in advance based on approaching an SOC low threshold. The timing and rate of recharging may also be opportunistically selected to maintain voltage and SOC within predetermined ranges.

While not shown, the vehicle 112 includes an accelerator pedal that enables the driver to request torque. The vehicle may be programmed to determine a driver-demanded torque based on a position of the accelerator pedal and vehicle speed. The driver-demanded torque may be a raw wheel torque that is commanded by the driver and is used to control the torque produced by the motors 114.

The above-described battery assembly 124 may include a plurality of battery cells that may be arranged in one or more arrays that each includes tens or even hundreds of battery cells electrically connected to each other in series, parallel, or combination thereof. The battery cells may be cylindrical, prismatic, pouch, or other type of cell shape.

The above-described vehicle example is but one application for the below described battery cell. It is to be understood that the battery cell may be used in any suitable application including vehicle and non-vehicle applications.

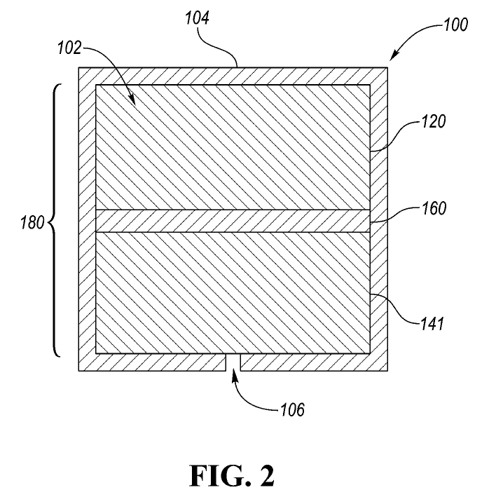

FIG. 2 shows an example battery cell 100 that may be used in the traction battery 124 or any other suitable battery. The battery cell 100 may be lithium-ion (Li-ion) or other chemistry. Generally, the cell 100 includes one or more unit cells 102 disposed within an outer housing 104. The structure of the outer housing 104 varies by battery type. For example, in pouch cells, the outer housing is a thin flexible material that is generally referred to as a “pouch.” In prismatic cells, the outer housing is a rigid material, e.g., metal, and is generally referred to as a “can.”

For simplicity, the battery cell 100 is shown with a single unit cell 102 but may include more in other embodiments. The unit cell 102 includes a negative electrode (anode) 120, a positive electrode (cathode) 141, and a separator 160 disposed between the anode 120 and cathode 141. Positive and negative current collectors and terminals (not shown) are joined to the anode 120 and cathode 141 allowing the cell 100 to output electricity. The anode may contain hard carbon, the graphite-like carbon, including natural and artificial graphite, metal mixed oxide (lithium metal), and lithium alloy (a silicon group alloy may be used as the anodal active material). The separator 160 may be formed of any suitable material. In at least one embodiment, the separator 160 includes a polyolefin, such as polyethylene or polypropylene. An electrolyte 180 may be disposed within the battery cell to be in contact with anode 120, cathode 141, and/or separator 160. In at least one embodiment, the electrolyte includes a lithium salt and an organic solvent. Examples of suitable lithium salts include, but are not limited to, LiPF6, LiBF4 and LiClO4. The organic solvent may include ethylene carbonate (EC), dimethyl carbonate (DMC), and/or diethyl carbonate (DEC), and any combination thereof, as well as other suitable organic solvents. In at least one embodiment, the organic solvent is a combination of EC and DEC in a 3:7 ratio by volume (v/v). Other suitable electrolytes may include ionic liquid electrolytes and aqueous electrolytes.

The battery cell 100 includes a window 106 that allows external optical spectroscopy of internals of the battery cell. Battery cells are complex electrochemical systems that are difficult to evaluate after assembly due to being enclosed in an aluminized film or case. Once a cell is manufactured, electrochemical performance metrics can be measured via the cell tabs (i.e., impedance, power capability, etc.). However, such parameters may be a function of several variables and may not relate directly to a process of interest or fully define the electrochemical state. Additional testing can be performed early in the cell formation process to quantify gas generated from the chemical reactions that take place during the initial cycles. For example, gases generated during formation may be collected in a side gas bag attached to the main battery pouch. After the formation process, the cells are indexed to another station where the gas bag is vented. At this point, a mass spectrometer may be used to analyze the final gas composition, but this method does not allow for gas analysis at later points in the cell manufacturing process or post manufacturing. While detection of gas composition early in the formation process can be used to determine the initial state, health, and safety of a cell, it cannot be used later in the cell’s life cycle. At present, non-destructive methods of cell inspection are illusive and this disclosure addresses the current limitations in the art by providing a window that allows optical spectroscopy of internals of the battery cell. Discussed herein are battery cells having a window and methods for inspecting the battery cell using the window.

As will be discussed further herein, the battery cells and methods of this disclosure enable in-situ optical spectroscopy for the analysis of gas formation and chemical reactions in the battery cell through an optical window that may be integrated into the outer packaging of the battery cell. Optical access can be achieved via a window that is transparent to at least some spectrums of electromagnetic radiation, e.g., near-, mid-, and far-infrared. The window assembly may be a composite of different materials that impart different characteristics. For instance, the window may be a plastic film with an additional thin metal film layer that provide a combination of gas impermeability, flexibility, and light transmission. The window may include components to impart non-optical characteristics too. Components around the circumference or perimeter of the window can be used to interface with the battery cell housing, including mechanical compliance and cohesion. Similarly, the window assembly is compatible with pouch, cylindrical or prismatic cell assembly methods. Cell integration may require electrolyte-solvent tolerant adhesive or thermopolymer layers that can adhere to the cell housing or melt into the housing during lamination. Integration into different battery housings may require windows that are circular, square or rectangular in cross section. The casing integration may also be achieved through a rigid, threaded or crimped compression fitting with a gas seal. The window may include full or partial coverage with anti-reflective or reflective coatings, used to enhance transmission or reflection of desired wavelengths or to form an interferometer to measure or affect beam-pathlength within the device. An example of an interferometer is embodied as a Bragg interferometer; this can also be integrated into the window to enable temperature measurement simultaneous to gas characterization. The window may include coatings that affect the wavelength of light in other ways too, such as photoluminescence or absorptive filtering to enable greater spectroscopic selectivity. The window assembly may also include an additional component that enhances durability of the optical surface, such as a hinged dust cover, a recessed position or anti-abrasion coatings. The below figures and associated text provide example embodiments of the optical window.

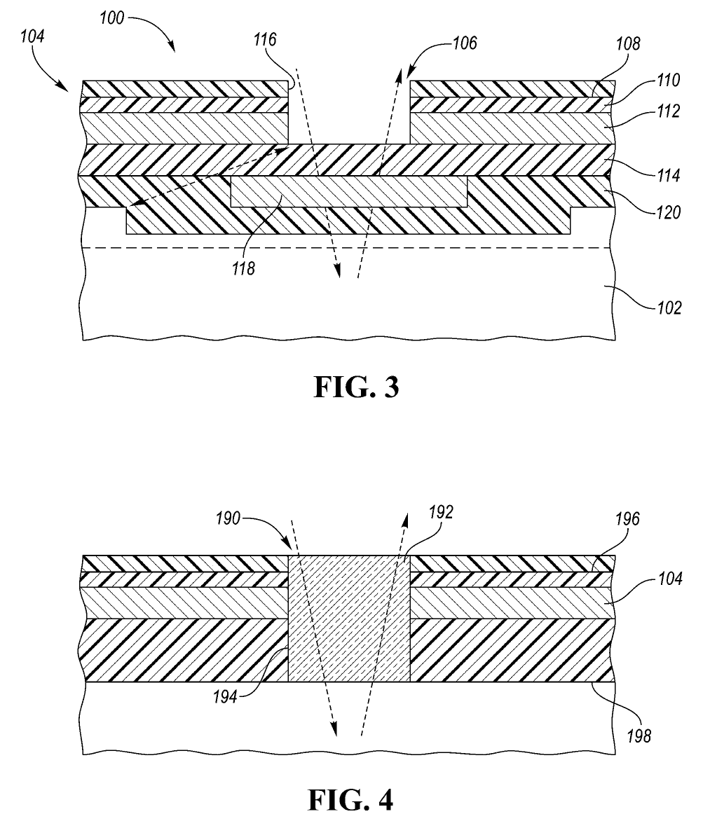

FIG. 3 illustrates one example of an optical window 106 that allows for spectroscopic inspection of the battery cell 100. The optical window 106 may be directly integrated into the housing 104 during the manufacturing process or could be added in a secondary procedure using commercially available pouch film.

The window 106 may be defined in the housing 104. In this example embodiment, the battery cell 100 is a pouch-style cell and the housing 104 is formed of multiple layers including a non-metal outer layer 108 (e.g., PET), a second layer 110 (e.g., nylon), a third layer 112 (e.g., metal, such as aluminum), and an inner layer 114 (e.g., polyethylene). The description of the layers are merely an example and the housing 104 may be constructed differently in other embodiments. For example, the housing 104 may include more or less layers and/or different materials for the layers.

In the illustrated example, the window 106 includes an aperture 116 defined in the housing 104 and a layer of material 118 disposed under the aperture 116. The aperture 116 extends at least partially through the housing 104. In the illustrated example, the aperture 116 extends from the outer surface defined on the outer layer 108 to the innermost layer 114. Therefore, the aperture 116 extends through the layers 108, 110, and 112 but not through the innermost layer 114. The innermost layer 114, which may be formed of polyethylene, does not interfere with the spectral analysis and thus may be maintained to provide desired sealing of the battery cell 100.

The layer of material 118 is at least partially transparent to electromagnetic radiation allowing for spectroscopic inspection of the battery cell 100. In the illustrated example of FIG. 3, the layer of material 118 is a metalloid foil that is at least partially transparent to infrared radiation. The metalloid foil may consist essentially of silicon or germanium, for example. The metalloid foil 118 provides the window 106 with the desired transparency in select wavelengths of electromagnetic radiation while also being substantially impermeable to gas penetration thus sealing the cell as if the window were not present. The foil 118 may have a thickness on the order of 10 microns.

The metalloid foil 118 may be disposed against the inner layer 114 of the housing 104. For example, the metalloid foil 118 may be bonded to the inner layer 114. The metalloid foil 118 may be bonded using a polymer layer 120. Here, the polymer layer 120 may encapsulate the metalloid foil to provide a corrosion resistant barrier to the unit cell(s) 102 within the battery cell 100. The polymer layer 120 may also be formed of polyethylene, which bonds well to the polyethylene layer 114 of the housing 104. Polyethylene is merely one example material for the polymer layer 120, but the material chosen should be at least partially transparent to the electromagnetic radiation used in the spectroscopic inspection.

To increase the sealing effect, the metalloid foil 118 is larger than the aperture 116 creating an overlap. This is shown in the cross-section of FIG. 3 where the metalloid foil extends past the periphery of the aperture 116. This overlap may be formed by making the cross-sectional area of the aperture 116 smaller than the cross-sectional area of the metalloid foil 118. In one or more embodiments, the aperture 116 is circular as is the metalloid foil 118. Here, the diameter of the metalloid foil 118 may be larger than the aperture 116 to create the desired overlap. The overlap increases the distance (green arrow) that gas must travel to permeate through the window. The longer the distance, the more impermeable the window is to gas penetration. The outside of the aperture 116 may remain empty or may be filled with a filler material.

FIG. 4 illustrates an alternative embodiment having a window 190. Like the above example, the window 190 includes an aperture 194 formed in the housing 104 of the battery cell. In this embodiment, the aperture 194 is shown as extending completely through the housing 104, that is, from the outer surface 196 to the inner surface 198. In other embodiments, the aperture 194 may only extend partially through the housing 104, like the aperture 116. In this embodiment, metalloid foil is not used and instead the aperture 194 is filled with a polymer 192. The polymer 192 has a low gas permeability to maintain sufficient sealing of the battery cell.

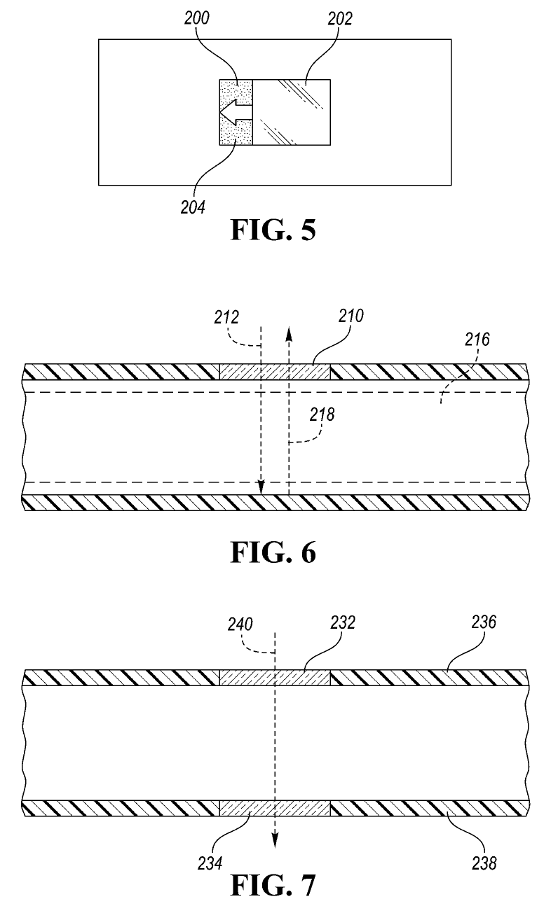

FIG. 5 illustrates an example cover 200 that may be used to cover the aperture 202 of the window 204 when not in use. The cover 200 may include a planar body 204 that is movable between a first position in which the planar body 204 covers the aperture 202 and a second position in which the planar body 204 is distal to the aperture 202. For example, the cover may slide, hinge, flex, or detach to provide the second, removed position that exposes the aperture 202.

The above described windows are described as being provided on the battery cell itself, however, the above described windows could also be provided on the gas pouch used during production of the battery cell.

Different spectroscopic techniques may be applied to a battery cell or gas pouch via either a transmission or reflection geometry. Reflection only requires a single window (FIG. 6), whereas transmission (FIG. 7) requires two windows.

Referring to FIG. 6, the reflection method requires a single window 210 that is used for both illumination and detection. In this way, light 212 enters through the window 210 and reflects off the opposing pouch surface 214 or unit cell 216. The inspection system then analyzes the reflected light 218.

Referring to FIG. 7, a battery cell or gas bag 230 has two windows 232 and 234. The windows 232 and 234 are disposed on opposing sides 236 and 238 of the battery cell/gasbag 230. The windows 232, 234 are aligned with each other such that a line orthogonal to the sides of the battery cell/gasbag 230 pass through both windows. In the transmission methodology, the light 240 enters on one side through window 232 and is detected through the second window 234.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery comprising:
a unit cell including a cathode, an anode, and a separator;
a housing encasing the unit cell and defining an aperture extending at least partially through a thickness of the housing; and
a metalloid foil disposed between the unit cell and the housing such that the metalloid foil spans the aperture, wherein the metalloid foil is at least partially transparent to infrared electromagnetic radiation.

2. The battery of claim 1 further comprising a polymer layer, wherein the metalloid foil is disposed in the polymer layer.

3. The battery of claim 2, wherein the polymer layer is polyethylene.

4. The battery of claim 1, wherein the housing includes a non-metal outer layer defining an outer surface of the housing, a metal intermediate layer, and a polymer layer defining an inner surface of the housing, wherein the metalloid foil is disposed against the polymer layer.

5. The battery of claim 4, wherein the aperture extends through the non-metal layer and the metal layer but not the polymer layer.

6. The battery of claim 1, wherein the metalloid foil has a surface area that is larger than a cross-sectional area of the aperture such that the metalloid foil extends past a periphery of the aperture.

7. The battery of claim 1, wherein a diameter of the aperture is less than a diameter of the metalloid foil.

8. The battery of claim 1, wherein the metalloid is silicon or germanium.

9. The battery of claim 1, wherein the metalloid foil is disposed against an inner surface of the housing.

10. The battery of claim 9, wherein the metalloid foil is bonded to the inner surface.

11. A battery comprising:
a battery cell including an optical window configured to allow external optical spectroscopy of internals of the battery cell, the window including:
an aperture formed in a housing of the battery cell, and
a layer of material spanning the aperture, wherein the layer of material is at least partially transparent to electromagnetic radiation and is configured to inhibit permeation of gases produced by the battery cell through the window.

12. The battery of claim 11, wherein the layer of material includes a metalloid foil.

13. The battery of claim 12, wherein the metalloid foil is at least partially transparent to infrared electromagnetic radiation.

14. The battery of claim 12, wherein the metalloid foil has a surface area that is larger than a cross-sectional area of the aperture such that the metalloid foil extends past a periphery of the aperture.

15. The battery of claim 12, wherein the metalloid film is disposed against an inner surface of the housing.

16. The battery of claim 11, wherein the layer of material includes a polymer.

17. The battery of claim 16, wherein the polymer fills the aperture.

18. A traction battery assembly comprising:
an array of battery cells, at least one of the battery cells including:
a housing defining an aperture extending inwardly from an outer surface of the housing; and
an infrared-transmissive metalloid foil disposed within the housing such that the metalloid foil spans the aperture.

19. The traction battery assembly of claim 18, wherein the infrared-transmissive metalloid foil is encased within a polymer layer.

20. The traction battery assembly of claim 18, wherein the infrared-transmissive metalloid foil has a surface area that is larger than a cross-sectional area of the aperture such that the infrared-transmissive metalloid foil extends past a periphery of the aperture.
